(19) United States
(12) Patent Application Publication
(10) Pub. No.: US 2016/0224702 A1
(43) Pub. Date: Aug. 4, 2016

(54) METHOD OF CALCULATING VOLTAGE AND POWER OF LARGE-SCALED PHOTOVOLTAIC POWER PLANT

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: MING MA, Beijing (CN); NING-BO WANG, Beijing (CN); SHI-EN HE, Beijing (CN); YAN-HONG MA, Beijing (CN); XU-SHAN HAN, Beijing (CN); ZI-FEN HAN, Beijing (CN); HUAI-SEN JIA, Beijing (CN); PENG ZHANG, Beijing (CN); GUANG-TU LIU, Beijing (CN); LONG ZHAO, Beijing (CN); QIANG ZHOU, Beijing (CN); DING-MEI WANG, Beijing (CN); JIAN-MEI ZHANG, Beijing (CN); QING-QUAN LV, Beijing (CN); MING-SONG WANG, Beijing (CN); ZHAO CHEN, Beijing (CN); YAN-LI ZHANG, Beijing (CN); KUN DING, Beijing (CN); JIN LI, Beijing (CN); SHI-YUAN ZHOU, Beijing (CN); LIANG LU, Beijing (CN); RONG HUANG, Beijing (CN); JIN-PING ZHANG, Beijing (CN); NIAN-ZONG BAI, Beijing (CN)

(21) Appl. No.: 15/011,631

(22) Filed: Jan. 31, 2016

(30) Foreign Application Priority Data
Jan. 30, 2015 (CN) 201510050089.7

(51) Int. Cl. G06F 17/50; G05F 1/66

(52) U.S. Cl. CPC G06F 17/5009; G05F 1/66

(57) ABSTRACT

A method of calculating voltage and power of large-scaled photovoltaic power plant includes following steps. Environment models of varies locations within the photovoltaic power plant are obtained. A photovoltaic display model is established by establishing a photovoltaic cell model, combining the photovoltaic cell model with the environment models, determining a combination of the environmental data on photovoltaic panels and the photovoltaic cell model, and determining a quantitative relationship between a photovoltaic cell power generation state and photovoltaic environment. An inverter model is obtained by modeling inverters connected to photovoltaic cells. A grid-side model is obtained. An electrical energy and voltage forecast model is constructed by integrated the photovoltaic display model, the inverter model, and the grid-side model. An energy output and a voltage quality of the photovoltaic power plant is calculated by detecting voltage and current of the electrical energy and voltage forecast model.

This application claims all benefits accruing under 35 U.S.C. §119 from China Patent Application 201510050089.7, filed on Jan. 30, 2015, in the China Intellectual Property Office, disclosure of which is incorporated herein by reference.

### BACKGROUND

1. Technical Field

The present disclosure relates to a method of calculating voltage and power of large-scaled photovoltaic power plant.

2. Description of the Related Art

At present, with the development of human, energy problem has become an important issue affecting the quality of human existence. One method to solve the energy problem is to develop clean energy, and optimize energy structure. Compared to the thermal power and hydropower, the wind energy and the solar power, as the representative of the new energy, has unique advantages, such as clean and pollution-free, renewable, subject to small geographical impact and so on. In this context, countries have begun to pay attention to and vigorously support the photovoltaic (PV) industry, and the photovoltaic industry has been rapidly developed. During “13th five-year-plan” period, the proportion of renewable energy will be significantly increased by 2020, and the generation installed capacity of the wind power and the PV power will reach 200 million and 100 million kilowatts or more respectively. The “13th five-year-plan” is the thirteenth development initiative of social and economic development of China. The former is twice times than the “Twelve five-year-plan” target, and the latter is five times than the “Twelve five-year-plan” target. In the coming decades, the PV industry has broad prospects. The “12th five-year-plan” is the twelfth development initiative of social and economic development of China.

The PV power plant is generally distributed at remote area and desert in a large amount. The local environments are quite different, and generally impacted by the external environment such as the light and temperature. This easily leads to large fluctuations in the output voltage, and affects quality of output voltage and the total power output capacity. Furthermore, the solar photovoltaic power generation system is composed of a plurality of solar modules connected in series or parallel. In the process of operation, because of the shadows, debris, dirt, bird droppings, photovoltaic panels aging, unified cell plate size, cloud cover or other factors, the efficiency of solar modules have been declined in different degrees. The efficiency reduction or damage in individual components will bring a substantial decline in the overall efficiency of the system.

With more PV power plants being constructed, the photovoltaic power plant location has received more and more attention. While a location may be selected for economic reasons, they will generally find a professional and technical staff to help assess whether the site is suitable for photovoltaic power plants. Selecting a location of photovoltaic power plants does not have a suitable standard, and the technical personnel usually operate relatively freely. Factors considered in the technical person usually include topography, landform, area, and policy conditions, etc. The technical person rarely assesses it from the perspective of power up.

Moreover, solar photovoltaic power generation system is composed of a number of solar modules connected in parallel and s series. In the process of operation, due to the large surface area covered by the solar photovoltaic power generation, differences in the local environment, impacted by the external environment such as the light and temperature, the volatility of the output voltage will be caused, and the quality of the output voltage and output power of the total capacity will be affected. In addition, the selection of the PV power plant structures and equipment also affects the quality of the output of electrical energy. For example, the maximum power point of different inverter MPPT algorithm for solar tracking speed and accuracy are very different, and the inappropriate algorithm can even cause voltage flicker occurrences. Another example is the rapidly changing weather conditions or complex cloud system the situation will lead to differences in output level of each panel, which can affect the overall output of the power station, and cause voltage fluctuations.

Voltage flicker hazards comprises following problems. (1) lights flashing, which causing human visual discomfort and fatigue, and affecting work efficiency; (2) TV screen brightness changes, and the magnitude of the vertical and horizontal shake; (3) motor speed is uneven, which impacts on product quality; (4) electronic instruments, computer, automatic control equipment is not working properly; (5) voltage fluctuation sensitive process or test results will be affected. Chinese National Standard GB12326-90 “power quality voltage fluctuation and flicker permit” has predetermined allowed voltage fluctuation in public power supply.

Because of the lack of a rigorous assessment considered from the perspective of power, the existing photovoltaic plant pre-construction tends to consider the assessment of the overall terrain, or estimate the size of the power plant, rarely assess the power and voltage quality. So many photovoltaic power plants find some of the issues before connected in the grid, and the photovoltaic power plant does not reach the network requirements. Then they go to look for problems, the replacement, or improvement of power plant equipment, which greatly delay the construction period, and increasing the cost.

What is needed, therefore, is a method of method of calculating voltage and power of large-scaled photovoltaic power plant to overcome the problems above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flowchart of one embodiment of a method of calculating voltage and power of large-scaled photovoltaic power plant.

FIG. 2 shows a block diagram of a circuit of one embodiment of an environmental data collection.

FIG. 3 shows a schematic diagram of one embodiment of a principle of a photovoltaic cell model.

FIG. 4 shows a schematic diagram of one embodiment of a main body model of inverter.

FIG. 5 shows a schematic diagram of one embodiment of a control circuit model of inverter.

FIG. 6 shows a schematic view of one embodiment of constructing an electrical energy and voltage forecast model of photovoltaic power plant.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

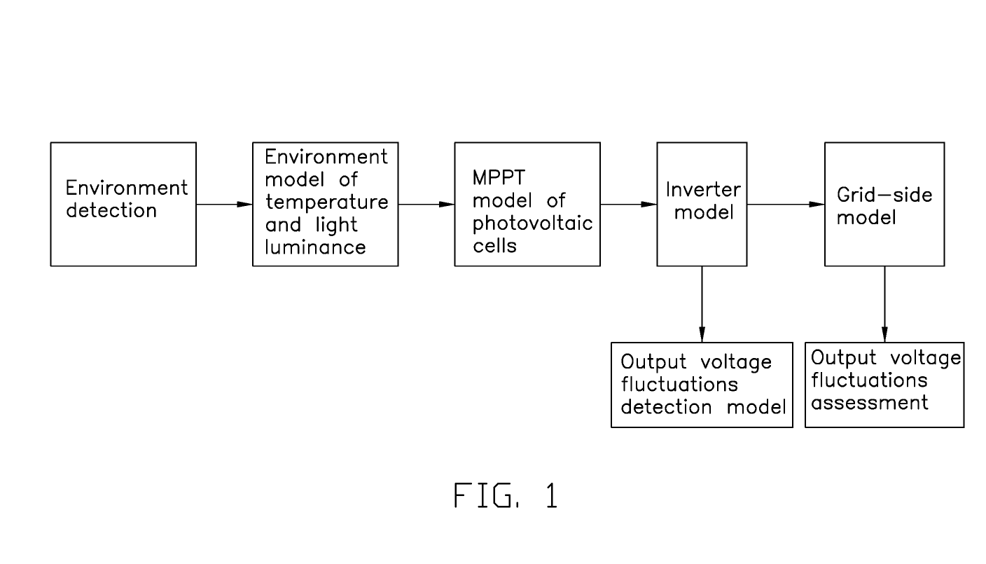

Referring to the FIG. 1, one embodiment of a method of calculating voltage and power of large-scaled photovoltaic power plant comprises:

Step 1, obtaining environment modes of each location within the photovoltaic power plant by processing environmental data collected around the photovoltaic power plant via binary interpolation method;

Step 2, establishing a photovoltaic display model by establishing a photovoltaic cell model, combining it with the environment model established in Step 1, to determine a combination of environmental data on photovoltaic panels and the photovoltaic cell model, and to determine the quantitative relationship between a photovoltaic cell power generation state and the environment;

Step 3, obtaining an inverter model by modeling inverters connected to the photovoltaic cells;

Step 4, obtaining a grid-side model by modeling grid-sides connected to the inverters;

Step 5, constructing an electrical energy and voltage forecast model of photovoltaic power plan by integrated the photovoltaic display model, the inverter model, and the grid-side model, wherein output data of the photovoltaic display model is taken as input data of the inverter model, and output data of the inverter mode is taken as input data of grid-side model; and

Step 6, calculating an energy output and voltage quality of the photovoltaic power plant by detecting voltage and current of the electrical energy and voltage forecast model.

Referring to FIG. 1, the implementation of the method of calculating voltage and power of large-scaled photovoltaic power plant will be specifically described in the form of modules, the modules include an environmental monitoring module, an environmental data processing module, a photovoltaic module, an inverter module, a power side module, an energy and voltage analog detection module, and voltage quality and output evaluation module.

Among them, the environmental monitoring module procedures wireless data collection via Zigbee wireless communication protocol, and obtains the environmental data of detection monitoring points. The environmental data processing module is responsible for processing the collected environmental data, establishes the environmental model of the entire photovoltaic plant by interpolation method, provides the required environmental data for the photovoltaic cell, and provides a data base of full station environment for the follow-up model. The photovoltaic cell model is established according to the characteristics of photovoltaic panels to transform the light energy into to DC model, which takes the affection of the environmental factors to the conversion efficiency of photovoltaic cells into account. The inverter model and the grid-side model convert the direct current of the photovoltaic cells into alternating current output.

The photovoltaic display model, the inverter model, and the grid-side model are simulation models, which convert the solar energy of photovoltaic power plant into DC and AC. The models are established primarily based on PSCAD/EMTD platform. The voltage and power detection module, is configured to detect the voltage quality of grid connection points, as well as gives a more accurate estimate to the total amount of energy input into the grid.

The environmental monitoring module collects the environmental data around the area wherein the photovoltaic power plant is located, especially the light intensity and the temperature data, processes the collected environmental data, and obtains the overall environmental information of the photovoltaic power plant in order to assess the follow-up voltage output.

Because the photovoltaic power plant covers large area, there will be some differences between the local environment data, and it need to place a plurality of collection points to accurately simulate the environment as possible. Because the distance between the adjacent two collection points can be adjusted, the required data rate is not so high, and the Zigbee wireless communication protocol can be adopted. The Zigbee wireless communication protocol has advantages such as low power, low bandwidth, high networking capability, et al., thus it is particularly suitable for collecting wireless sensor data in the field.

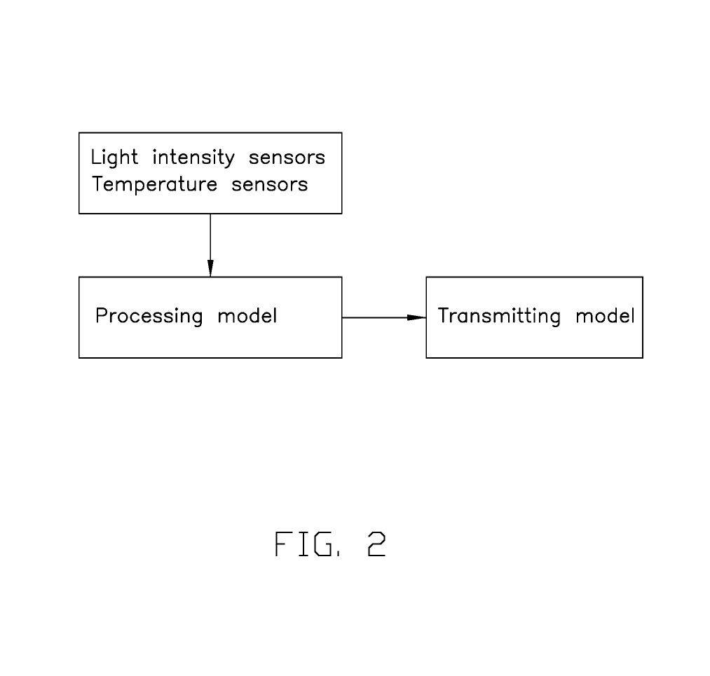

Referring to FIG. 2, the wireless sensor data is collected via Zigbee wireless communication protocol. In the collecting and sending terminal, it adopts light intensity sensors and temperature sensors to collect the environmental data. After the environmental data is processed by adding geographic coordinate information via a processing module, the environmental data is transmitted by a transmitting sensor. Because the Zigbee wireless communication protocol has a self-networking feature, thus the environmental data will be sent the coordinator after forwarded by a routing. After the antenna of the coordinator receives the environmental data from network, the environmental data will be aggregated and sent to the upper computer via serial port, and subsequently processed by the upper computer.

Environmental data processing module: the collected data comprises environmental data and corresponding geographic coordination information obtained at an isolated point in a typical environment in the photovoltaic power plant. The collected data is transmitted via Zigbee wireless communication protocol, aggregated on coordinator, and transmitted to the PC terminal via the serial port. The PC terminal processes the received data via binary interpolation method to obtain the interpolation function at any point in the entire photovoltaic power plant, which can simulate and obtain the environmental data of the photovoltaic cell at on each location.

The method is described in detail as follows:

setting a real function: f (x y), wherein the values of the real function are the measured temperature or light luminance values;

defining a rectangular area: D={a<x<b,c<y<d}, wherein the rectangular area is the photovoltaic array region;

interpolating node set which is the coordinate position of the measuring points of the photovoltaic environment:

Z={(xi, yj)|a<x0<x1< . . . <xn< . . . <b, c<y0<y1< . . . <ym< . . . <d};

taking a function group which is linearly independent from Z:

{φₖᵣ(x, y)|k=0, 1 , . . . , n; r=0, 1, . . . , m};

wherein φₖᵣ(x, y) is a bivariate polynomial in which the degree of φₖᵣ(x, y) is not more than n times about x, and not more than m times about y;

In the function space:

D=Span{φ₀₀, . . . , φ₀ₘ, . . . , φₙ₀, . . . , φₙₘ}, a bivariate interpolation polynomial is searched:

pₘₙ(x, y)=Σₖ₌₀ⁿ Σᵣ₌₀^{m} c_{k,r} φₖᵣ(x, y),

wherein c_{k,r} is a coefficient value corresponding to each interpolation basis function;

selecting an interpolation basis function of bivariate Lagrange polynomial interpolation method:

$${ϕ}_{rk} ( x , y ) = {l}_{k} ( x ) {l}_{r} ( y ) ;$$

$${l}_{k} ( x ) = {\prod }_{t = 0 , t \neq k}^{n} \frac{x - {x}_{t}}{{x}_{k} - {x}_{t}} , \\ wherein$$

$${l}_{r} ( x ) = {\prod }_{t = 0 , t \neq k}^{n} \frac{y - {y}_{t}}{{y}_{k} - {y}_{t}} ;$$

$${l}_{k} ( x ) = {\prod }_{t = 0 , t \neq k}^{n} \frac{x - {x}_{t}}{{x}_{k} - {x}_{t}}$$

is the specific form of Lagrange interpolation basic function along x direction; the Lagrange interpolation basic function can ensure that the value of the basic function is 1 at interpolation point, and 0 at other points;

$${l}_{r} ( y ) = {\prod }_{t = 0 , t \neq k}^{n} \frac{y - {y}_{t}}{{y}_{k} - {y}_{t}}$$

is similar.

So as to satisfy the interpolation condition: pₘₙ(xᵢ, yⱼ)=f(xᵢ, yⱼ),

wherein i—0, 1 . . . n, j—0, 1 . . . m. The binary interpolation function satisfy the interpolation condition is uniquely existed.

While f(xᵢ, yⱼ) is dynamically changed over time, the binary polynomial interpolation will be also dynamically changed over time, that is:

$${p}_{mn} ( x , y , t ) = {\sum }_{k = 0}^{n} {\sum }_{r = 0}^{m} {c}_{k , r} ( x , y ) {ϕ}_{kr} ( x , y , t ) .$$

Through the above-described environmental data collection and processing operations, the environmental parameters under typical weather conditions at the region can be obtained by interpolation, such as the effect to the light intensity and temperature caused by weather such as rain, snow, sunny, or cloud cover.

Modeling photovoltaic cells: photovoltaic cells are the main part of the photovoltaic power plants, and they are also the equipment to directly convert solar energy into electrical energy. When preliminary assessment of the situation of the photovoltaic power plant, it is necessary to modeling the photovoltaic panels. In one embodiment, the photovoltaic cell model comprises:

At any solar radiation intensity R (w/m²) and the ambient temperature Ta (␣), the photovoltaic panel temperature is:

Tc=Ta+a×R+b×∫ₜ₀^{t}Rdt;

wherein the coefficients a and b are related to the properties of photovoltaic panels, and they are constant;

assuming at reference conditions, I_{sc} is the short-circuit current, V_{oc} is the open circuit voltage; Iₘ, Vₘ, is current and voltage at maximum power point respectively; then while the voltage of photovoltaic array is V, the corresponding current is I, thus:

$$I = Isc \times ( 1 - C 1 ( \frac{V}{{e}^{C 2 \times Voc} - 1} ) ) ;$$

$$wherein \text{:}$$

$$C 1 = ( 1 - \frac{Im}{Isc} ) {e}^{- \frac{Vm}{C 2 Voc}} , \\ C 2 = ( \frac{Vm}{Voc} - 1 ) / ln ( 1 - Im / Isc ) ;$$

while the effects of radiation intensity and temperature is taken into account, then:

$$I = Isc \times ( 1 - C 1 ( \frac{V - DV}{{e}^{C 2 \times Voc}} - 1 ) ) + DI ;$$

$$wherein \text{:}$$

$$DI = α * \frac{R}{Rref} * DT + ( \frac{R}{Rref} - 1 ) * Isc ;$$

$$DV = - β * DT - Rs * DI ;$$

$$DT = Tc - Tref ;$$

wherein the parameter Rref represents the solar radiation reference value; and the parameter Tref represents photovoltaic cell temperature reference value; the parameter Rref is generally 1 kW/m²; the parameter Tref is generally 25° C.; Rs is the series resistance of photovoltaic modules, α is the temperature coefficient of the current variation, β is the temperature coefficient of the voltage variation, R is the resistance of the photovoltaic module.

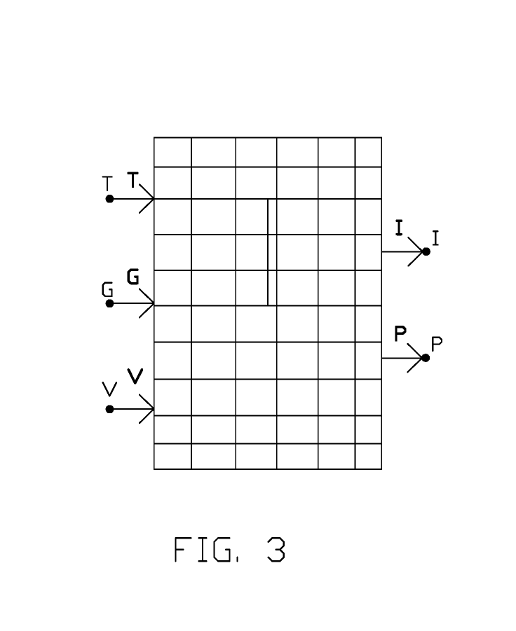

The constructed photovoltaic cell model is shown in FIG. 3, wherein T, G, V represents ambient temperature, light intensity, the voltage between two opposite ends of the photovoltaic panel respectively; I and P represent the output current and power respectively. The photovoltaic cell model can be equivalent to the entire photovoltaic panel via controlling a current source by the output current I.

Inverter model: output of the photovoltaic cells is direct current, and the inverter is used to convert DC to AC. In the photovoltaic power plants, the plurality of photovoltaic cells are connected in series or parallel and then aggregated into the inverter. The inverter converts DC from photovoltaic cells into AC and transmits AC with industrial frequency into the power grid. The structure of inverter is complicated, mainly comprises the inverter bridge, inverter controller, and filter circuit. The inverter bridge is generally consists of IGBT or a three-phase full bridge comprising thyristor, achieves the DC to AC conversion by transferring phases of current by switching power devices. The inverter controller is the most flexible part in the inverter, and the impact on the performance of the inverter is also the largest. The inverter controller is not only to achieve tracking the maximum power of the photovoltaic power generation, but also to achieve effectively controlling active and reactive power output. The MPPT usually adopts admittance method, the power control usually adopts current inner loop method, and adopts SVPWM to control the inverter bridge. The task of the filter circuit is to suppress the possible output of the high-order harmonic wave as possible, and improve the quality of voltage.

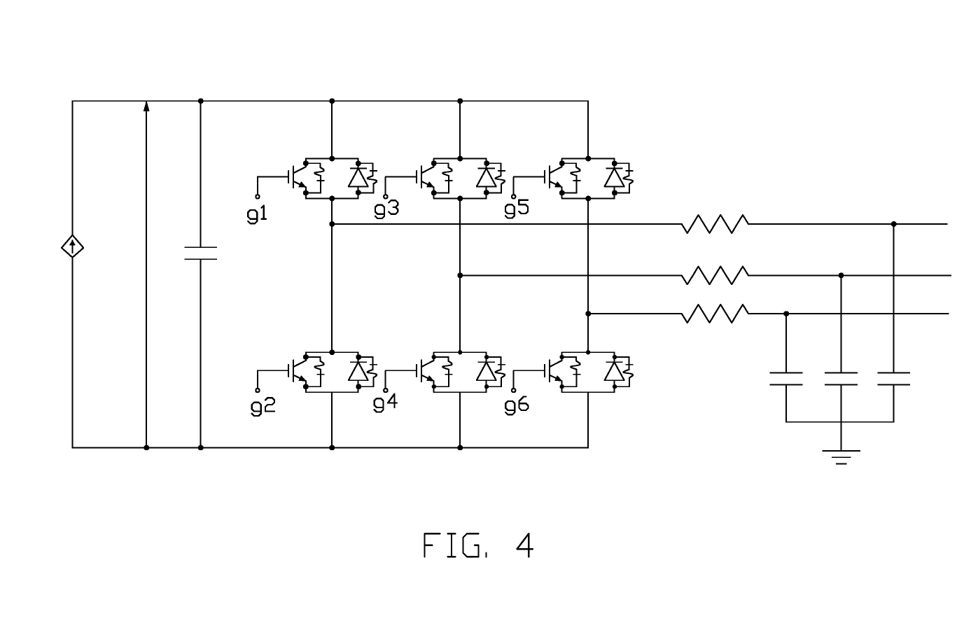

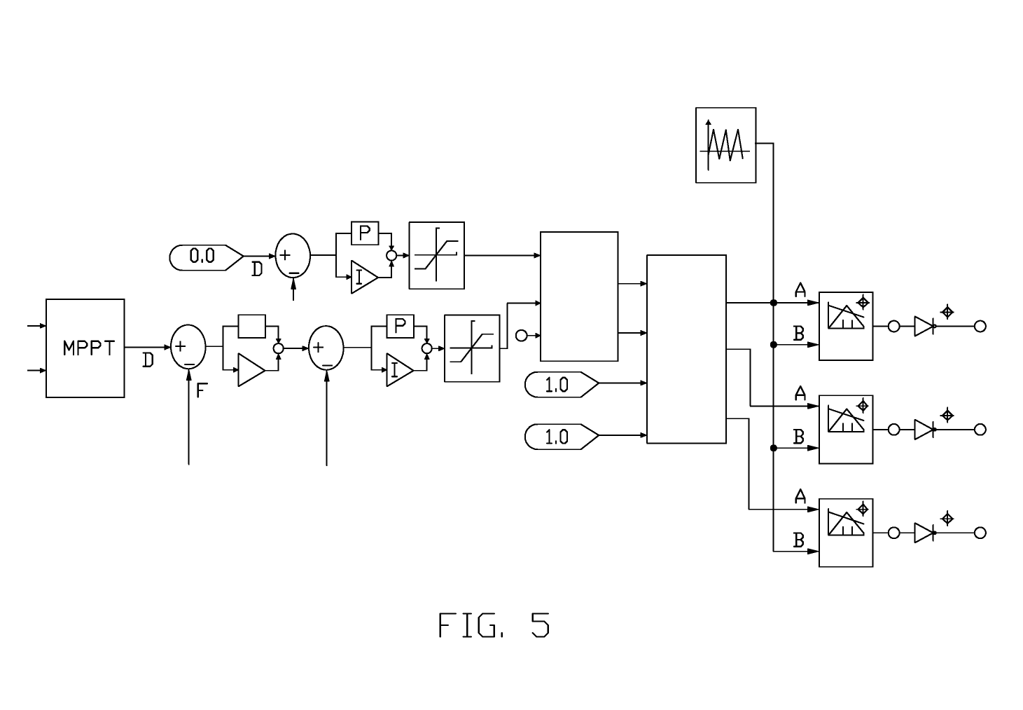

FIG. 4 is a model of the main inverter, and FIG. 5 is a model of inverter control circuit.

Grid-side models: the grid is the transport medium for energy, the photovoltaic power plants connected to the grid via public access points. Load is an important part of the power system, so in order that the actual results of the analysis is closer to engineering, the mathematical load model must be established. The load model is used to simulate the load with constant impedance, namely that the impedance value in load is maintained in the transient process constant, the value is determined by the power absorbed by the load and the voltage of the load node under the steady-state condition before the disturbance.

Power output and voltage detection is mainly used to measure the voltage and current models voltage of access points, in order to calculate the energy output as well as voltage quality of photovoltaic power plant.

When the three-phase load is at balance, the apparent power, active power, and reactive power of the photovoltaic power plant can be calculated by the following formula:

Apparent power: S=\sqrt{3}×U×I;

Active power: S=\sqrt{3}×U×I×cos φ;

Reactive power: S=\sqrt{3}×U×I×sin φ;

where U, I was line voltage and line current, and Φ is the phase difference between voltage and current.

Voltage quality usually include voltage deviation, voltage frequency deviation, voltage unbalance, voltage transients, voltage fluctuation and flicker, voltage sags (provisional liters) and interrupt, voltage harmonics, voltage notch, undervoltage, and overvoltage, etc. The indicators related to voltage flicker of photovoltaic power plants are detected here. The flicker detection module is a module to detect the voltage flicker at the access points of photovoltaic power station. Grid voltage fluctuations are generally considered to an amplitude modulated wave carried by industrial voltage, the square demodulation method can be used to detect the modulated signal, and then calculate the instantaneous flicker sensation level S(t) and short-term flicker value Pst.

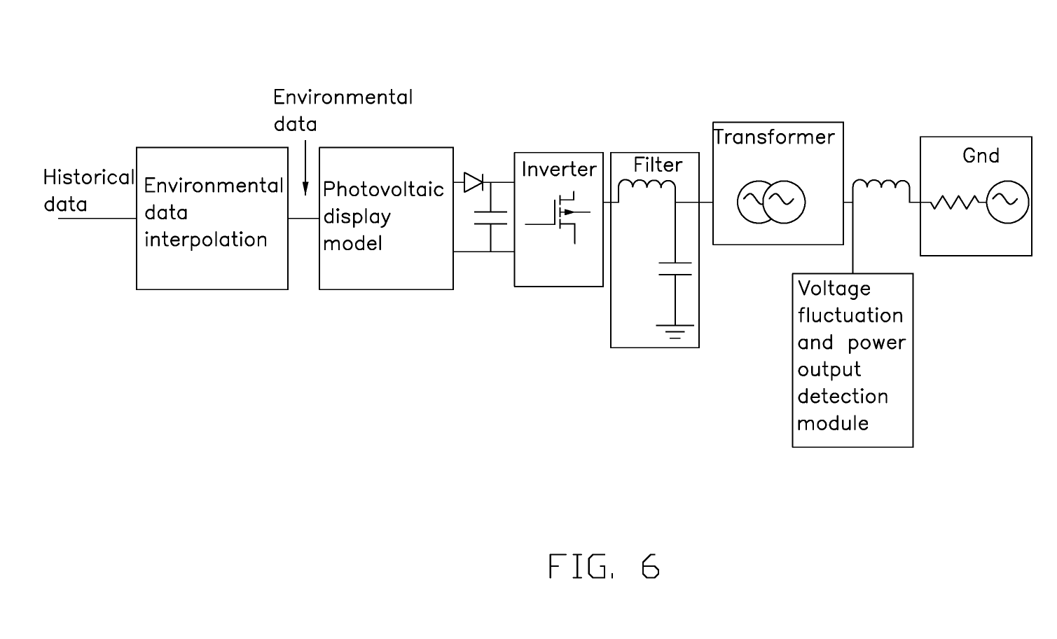

By combining the above modules, the voltage and energy situation forecast model of large-scale photovoltaic power plants can be shown in FIG. 6, and the model shows the relative position of each module.

In summary, the method of method of calculating voltage and power of large-scaled photovoltaic power plant has the following advantages.

(1) The method provides an early model for the photovoltaic power plant builders, the model can be used to simulate a variety of station program and to assess the feasibility of the program based on the results. The method can avoid unnecessary post-secondary transformation power plant as much as possible, and can reduce a lot of manpower and material costs.

(2) The method can be used to predicate and assess the theoretical output of large photovoltaic power plant process in running. That is due to the shadows, debris, dirt, bird droppings, photovoltaic panels aging, the uniform size of photovoltaic panels, cover or other factors, the efficiency of solar modules have different degrees of decline, the individual components reduced efficiency or damage will bring substantial decline in efficiency into the entire system. Therefore, the use of metering stations, geographical environment, run aging data, consider the PV array unit interrelated factors, build simulation models to assess the overall theory output of the complex environment of photovoltaic power plant, predicates theoretical output of the large-scale photovoltaic power plants will helps security, economic operation, and maintenance of photovoltaic power generation system maintenance, and the predictions of photovoltaic output can be assisted dispatching operation control decisions, improve the stability of photovoltaic power grid.

(3) The photovoltaic power plant covers large area, there are some differences in the local environment data, and therefore need to place different collection points to accurately simulate the environment as possible. The Zigbee wireless communication protocol is applied to the detection of environment node in distributed large-scale photovoltaic power plants, the establishment of Zigbee acquisition program topological structure, which is very suitable for collecting the wireless sensor data of outdoor distributed photovoltaic power plant environment node.

(4) The model utilize the measured point of binary difference to establish the dynamic parameters model of photovoltaic power plant in complex environmental factors, the model provides key parameters for the following predication of voltage and power state.

(5) The photovoltaic cell model, the inverters model, and the grid-side model is completed on PSCAD/EMTD platform has following advantages. First, the simulation scale can be enlarged through connecting the photovoltaic cells and inverter in series and parallel. Second, the photovoltaic cell model, the inverter model, and the grid-side model can be modification by the open type of model parameters. Third, it is convenient to facilitate the voltage, current, and output detection of simulation model t, and analysis of transient characteristics.

(6) The grid voltage fluctuations are generally considered as the amplitude modulated wave carried by the industrial frequency voltage, the square demodulation method can be used to detect the modulated signal, and then calculate the instantaneous flicker sensation level S(t) and short-term flicker value Pst.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of calculating voltage and power of large-scaled photovoltaic power plant, the method comprising:
obtaining environment models of varies locations within a photovoltaic power plant by processing environmental data collected around the photovoltaic power plant via binary interpolation method;
establishing a photovoltaic display model by establishing a photovoltaic cell model, combining the photovoltaic cell model with the environment models, determining a combination of the photovoltaic cell model and the environmental data in a plurality of locations, and determining a quantitative relationship between a photovoltaic cell power generation state and photovoltaic environment;
obtaining an inverter model by modeling inverters connected to photovoltaic cells;
obtaining a grid-side model by modeling grid-sides connected to the inverters;
constructing an electrical energy and voltage forecast model of the photovoltaic power plan by integrating the photovoltaic display model, the inverter model, and the grid-side model, wherein output data of the photovoltaic display model is taken as input data of the inverter model, and output data of the inverter mode is taken as input data of the grid-side model; and
calculating an energy output and a voltage quality of the photovoltaic power plant by obtaining voltage and current of the electrical energy and voltage forecast model.

2. The method of claim 1, wherein the binary interpolation method comprises:
setting a real function: f (x, y), wherein values of the real function are measured temperature or light luminance values;
defining a rectangular area: D={a<x<b, c<y<d}, wherein the rectangular area is a photovoltaic array region;
interpolating node sets, wherein the node sets are coordinate positions of measured points of the photovoltaic environment:
Z={(xi, yj)|a<x0<x1< . . . <xn< . . . <b, c<y0<y1< . . . <ym< . . . <d};
taking a function group which is linearly independent from Z:
{φₖᵣ(x, y)|k=0, 1,, . . . , n; r=0,1, . . . , m};
wherein φₖᵣ(x, y) is a bivariate polynomial in which a degree of φₖᵣ(x, y) is not more than n times about x, and not more than m times about y; in a function space:
D=Span{φ₀₀, . . . , φ₀ₘ, . . . , φₙ₀, . . . , φ_{nm},}
a binary polynomial interpolation is searched:
pₘₙ(x, y)=Σₖ₌₀ⁿ Σᵣ₌₀^{m} c_{k,r} φₖᵣ(x, y),
wherein c_{k,r} is a coefficient value corresponding to each interpolation basis function;
selecting an interpolation basis function based on bivariate Lagrange polynomial interpolation method:
$${ϕ}_{rk} ( x , y ) = {l}_{k} ( x ) {l}_{r} ( y ) ;$$
$${l}_{k} ( x ) = {\prod }_{t = 0 , t \neq k}^{n} \frac{x - {x}_{t}}{{x}_{k} - {x}_{t}} , \\ wherein$$
$${l}_{r} ( y ) = {\prod }_{t = 0 , t \neq k}^{n} \frac{y - {y}_{t}}{{y}_{k} - {y}_{t}}$$
wherein
$${l}_{k} ( x ) = {\prod }_{t = 0 , t \neq k}^{n} \frac{x - {x}_{t}}{{x}_{k} - {x}_{t}}$$
is a specific form of the Lagrange interpolation basic function along x direction; the Lagrange interpolation basic function ensure that a value of the interpolation basic function is 1 at interpolation point, and 0 at other points;
$${l}_{r} ( y ) = {\prod }_{t = 0 , t \neq k}^{n} \frac{y - {y}_{t}}{{y}_{k} - {y}_{t}}$$
is a specific form of the Lagrange interpolation basic function along y direction; the Lagrange interpolation basic function ensure that a value of the interpolation basic function is 1 at interpolation point, and 0 at other points;
satisfying an interpolation condition: Pmn(xᵢ, yⱼ)=f(xᵢ, yⱼ),
wherein i=0, 1 . . . n, j=0, 1 . . . m; a binary interpolation function satisfy the interpolation condition is uniquely existed;
while f(xᵢ, yⱼ) is dynamically changed over time, the binary polynomial interpolation is also dynamically changed over time, which is:
$${p}_{mn} ( x , y , t ) = {\sum }_{k = 0}^{n} {\sum }_{r = 0}^{m} {c}_{k , r} ( x , y ) {ϕ}_{kr} ( x , y , t ) .$$

3. The method of claim 1, wherein the photovoltaic cell model comprises:
at any solar radiation intensity R (w/m²) and an ambient temperature Ta (° C.), a photovoltaic panel temperature is:
Tc=Ta+a×R+b×∫ₜ₀^{t}Rdt;
wherein coefficients a and b are related to properties of photovoltaic panels, and a and b are constant;
assuming at reference conditions, I_{sc} is a short-circuit current, V_{oc} is an open circuit voltage; Iₘ, Vₘ, is current and voltage at maximum power point respectively; then while a voltage of photovoltaic array is V, and a corresponding current I is:
$$I = Isc \times ( 1 - C 1 ( \frac{V}{{e}^{C 2 \times Voc} - 1} ) ) ;$$
$$wherein \text{:}$$
$$C 1 = ( 1 - \frac{Im}{Isc} ) {e}^{- \frac{Vm}{C 2 Voc}} , \\ C 2 = ( \frac{Vm}{Voc} - 1 ) / ln ( 1 - Im / Isc ) ;$$
while effects of radiation intensity and temperature are taken into account, then:
$$I = Isc \times ( 1 - C 1 ( \frac{V - DV}{{e}^{C 2 \times Voc}} - 1 ) ) + DI ;$$
$$wherein \text{:}$$
$$DI = α * \frac{R}{Rref} * DT + ( \frac{R}{Rref} - 1 ) * Isc ;$$
$$DV = - β * DT - Rs * DI ;$$
$$DT = Tc - Tref ;$$
wherein a parameter Rref represents a solar radiation reference value; and a parameter Tref represents a photovoltaic cell temperature reference value; Rs is a series resistance of photovoltaic modules, α is a temperature coefficient of a current variation, β is a temperature coefficient of a voltage variation, R is a series resistance of photovoltaic modules.
